(19) United States
(12) Patent Application Publication
(10) Pub. No.: US 2017/0367520 A1
(43) Pub. Date: Dec. 28, 2017

(54) METHODS AND APPARATUSES FOR BREWING A FLAVORFUL DRINK

(71) Applicant: Alexander Elijah Albanese, Oak Park, IL (US)

(72) Inventor: Alexander Elijah Albanese, Oak Park, IL (US)

(21) Appl. No.: 15/632,976

(22) Filed: Jun. 26, 2017

Related U.S. Application Data
(60) Provisional application No. 62/354,379, filed on Jun. 24, 2016.

(51) Int. Cl. A47J 31/18; A47J 31/06; G05B 19/02; A47J 31/36

(52) U.S. Cl. CPC A47J 31/18; A47J 31/0615; G05B 19/02; A47J 31/36

(57) ABSTRACT

An apparatus for brewing a flavored beverage includes a full immersion brewing vessel and an automated release mechanism with a hold position and a release position. The automated release mechanism in the hold position is configured for flavored particles in the brewing vessel to be fully immersed in water such that brewing of a flavored beverage occurs. The automated release mechanism in the release position is configured for brewing of the flavored beverage to be terminated via the force of gravity.

### RELATED APPLICATION

The instant application claims priority to U.S. Provisional Application Ser. No. 62/354,379 filed on Jun. 24, 2016, which is incorporated herein in its entirety by reference.

### FIELD OF TECHNOLOGY

The present disclosure relates to an apparatus and method for brewing coffee, tea or the like and more particularly to an apparatus and method employing a full immersion brewer with an automated release mechanism that terminates the brewing of the coffee, tea or the like via gravity.

### BACKGROUND

Brewing coffee, tea or the like involves bringing ground roasted coffee (ground coffee), tea leaves or the like into contact with water to infuse the water with the flavor of the grounds or leaves. Particular brewing devices are designed to practice variations of this method. For example, full immersion brewers pour water into a brewing vessel containing ground coffee, tea leaves or the like, such that the ground coffee, tea leaves or the like (ground coffee or tea) is fully submerged in the water. After a desired amount of time has elapsed, the water infused with flavor of the ground coffee or tea is poured out or drained from the brewing vessel, typically into a cup, to provide a cup of coffee, tea or the like (coffee or tea). However, leaving the water in the brewing vessel for time periods longer than desired may result in “over-brewed” coffee or tea that has an unpleasant taste. Such occurrences are not uncommon, particularly when individuals making a cup of coffee or tea are distracted and forget to pour the flavored water out of the brewing vessel until too much time has elapsed. Accordingly, a full immersion brewer with an automated release mechanism that automatically stops the brewing of the coffee or tea would be desirable.

### SUMMARY

The present disclosure is directed to novel apparatuses and methods for brewing a flavorful beverage. The present disclosure is directed toward an apparatus and method which may be viewed as an improvement in the full immersion brewing method. In that process flavored particles and water are combined in a brewing vessel such that the flavored particles are fully immersed in the water. As used herein the term “flavored particles” refers to ground coffee, tea leaves or the like.

In embodiments, an apparatus for brewing a flavored beverage includes a full immersion brewing vessel (also referred to herein simply as “brewing vessel”) and an automated release mechanism with a hold position and a release position. The automated release mechanism in the hold position is configured for flavored particles in the brewing vessel to be fully immersed in water such that brewing of a flavored beverage occurs. The automated release mechanism in the release position is configured for brewing of the flavored beverage to be terminated via the force of gravity.

In embodiments, the automated release mechanism includes an electronic timer and an automated drain valve. The automated drain valve may be positioned within a bottom opening of the brewing vessel and be in communication with the electronic timer. The automated drain valve is configured to automatically move from a closed position (i.e., the hold position) to an opened positioned (i.e., the release position) after a predetermined amount of time has elapsed on the electronic timer. When the automated drain valve moves from the closed position to the open position, brewing of the flavored beverage may be terminated by water infused with flavor from the flavored particles (flavored water) in the brewing vessel flowing out of the full immersion brewing vessel through the bottom opening via the force of gravity.

In some embodiments, the electronic timer and the automated drain valve may be located within a single unit positioned at a bottom portion of the brewing vessel and the electronic timer and the automated drain valve may be in wired communication with each other. In another embodiments, the electronic timer and the automated drain valve may be located in two separate units with the electronic timer and the automated drain valve in wireless communication with each other. In such an embodiment, one of the two separate units may be a personal electronic device (PED) comprising the electronic timer and the PED is in wireless communication with the automated drain valve.

In embodiments, the full immersion brewer may be a press brewer with a press filter and a weight configured to apply a downward force on the press filter via the force of gravity. In such embodiments, the automated release mechanism includes an electronic timer and an automated release lever. The automated release lever in the hold position may be positioned between the weight and the press filter when the press filter is in a brewing position. Brewing of the flavored beverage may be terminated by the press filter moving through the flavored water and separating the flavored water from the flavored particles after the release lever moves from the hold position to the release position and the weight applies the downward force on the press filter via the force of gravity.

In some embodiments, the electronic timer and the automated release lever may be located within a single unit and the electronic timer and the automated release lever are in wired communication with each other. In other embodiments, the electronic timer and the automated release lever may be located in two separate units with the electronic timer and the automated release lever in wireless communication with each other. In such an embodiment, one of the two separate units may be a PED comprising the electronic timer and the PED is in wireless communication with the automated release lever.

In embodiments, a process for making a flavored beverage with a full immersion brewer includes fully immersing flavored particles in water within a brewing vessel that includes an automated release mechanism and automatically terminating brewing of the flavored beverage via the force of gravity when the automated release mechanism moves from a hold position to a release position.

In some embodiments, the automated release mechanism includes an electronic timer and an automated drain valve described above. In such embodiments, flavored particles are fully immersed in water and after a time set on the electronic timer expires, the automated drain valve automatically moves from a closed position to an open position and brewing of the flavored beverage is terminated by flavored water in the brewing vessel flowing out of the brewing vessel through the bottom opening via the force of gravity.

In other embodiments, the process uses the brewing vessel noted above and the automated release mechanism includes an electronic timer and automated release lever as describe above. In such embodiments, flavored particles are fully immersed in water and after a time set on the electronic timer expires, the automated release lever automatically moves from a hold position to a release position and brewing of the flavored beverage is terminated by the press filter moving through the flavored water via the force of gravity and separating the flavored water from the flavored particles.

Additional features and advantages of the apparatuses and methods described herein will be set forth in the detailed description which follows, and in part will be readily apparent to those skilled in the art from that description or recognized by practicing the embodiments described herein, including the detailed description which follows, the claims, as well as the appended drawing.

It is to be understood that both the foregoing general description and the following detailed description describe various embodiments and are intended to provide an overview or framework for understanding the nature and character of the claimed subject matter. The accompanying drawings are included to provide a further understanding of the various embodiments, and are incorporated into and constitute a part of this specification. The drawing illustrates various embodiments described herein, and together with the description serve to explain the principles and operations of the claimed subject matter.

### BRIEF DESCRIPTION OF THE DRAWINGS

Other objects, advantages, and applications of the present disclosure will be made apparent by reviewing the following detailed description of the embodiments. The description makes reference to the accompanying drawings in which:

FIG. 1 schematically depicts a side view of a full immersion brewer according to one or more embodiments disclosed and described herein;

FIG. 2A schematically depicts a top view of an automated drain valve in a closed position according to one or more embodiments disclosed and described herein;

FIG. 2B schematically depicts the automated drain valve in FIG. 2A in an open position according to one or more embodiments disclosed and described herein;

FIG. 3 schematically depicts the electronic timer and automated drain valve in FIG. 2A as two separate components in wireless communication with each other;

FIG. 4 schematically depicts a side view of a press brewer with an automated release lever in a hold position according to one or more embodiments disclosed and described herein;

FIG. 5 schematically depicts a side view of the press brewer in FIG. 3 with the automated release lever in a release position according to one or more embodiments disclosed and described herein; and

FIG. 6 schematically depicts the electronic timer and automated release lever in FIGS. 4 and 5 as two separate components in wireless communication with each other;

### DETAILED DESCRIPTION

The preferred embodiments of the disclosure described herein are intended to brew a flavored beverage such as coffee, tea or the like and are described as such. However, the same structures or minor variations thereon could be used to brew tea leaves, herbs, or the like and use of the term coffee should not be taken as restrictive of the scope of the disclosure. Additionally, while the preferred embodiments may be described as brewing heated beverages, in general they are capable of making cold beverages such as iced tea, cold brewed coffee, or the like.

Directional terms as used herein—for example up, down, right, left, front, back, top, bottom, below, above—are made only with reference to the figures as drawn and are not intended to imply absolute orientation.

Unless otherwise expressly stated, it is in no way intended that any method set forth herein be construed as requiring that its steps be performed in a specific order, nor that with any apparatus specific orientations be required. Accordingly, where a method claim does not actually recite an order to be followed by its steps, or that any apparatus claim does not actually recite an order or orientation to individual components, or it is not otherwise specifically stated in the claims or description that the steps are to be limited to a specific order, or that a specific order or orientation to components of an apparatus is not recited, it is in no way intended that an order or orientation be inferred, in any respect. This holds for any possible non-express basis for interpretation, including: matters of logic with respect to arrangement of steps, operational flow, order of components, or orientation of components; plain meaning derived from grammatical organization or punctuation, and; the number or type of embodiments described in the specification.

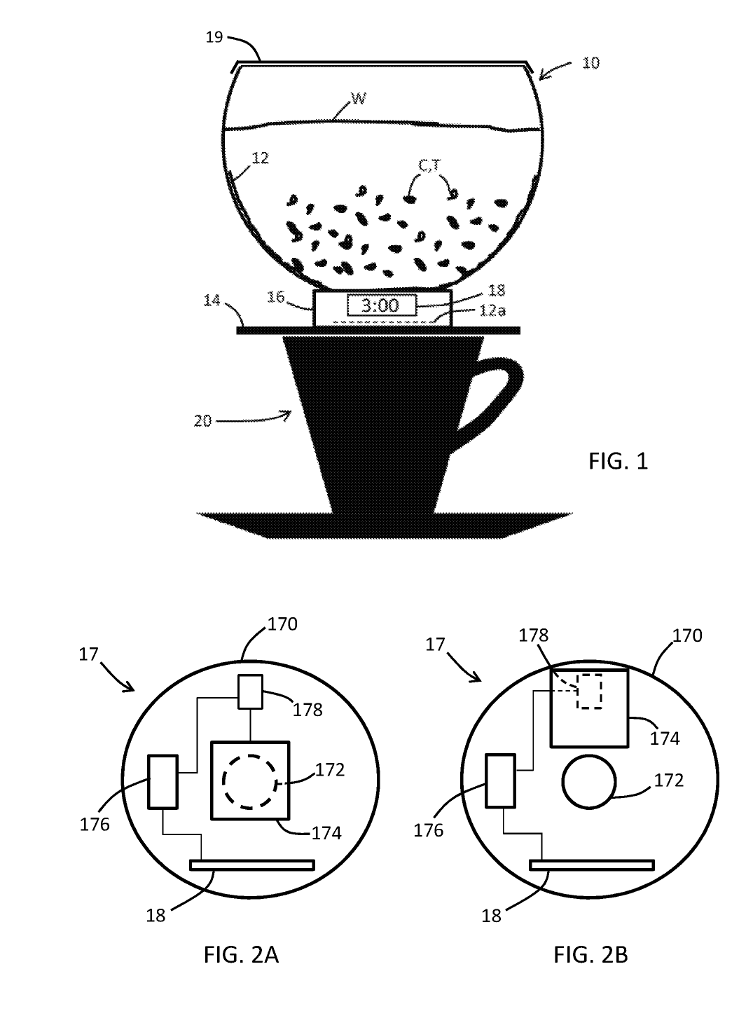

Referring to FIG. 1, apparatuses for brewing a flavored beverage includes a brewing vessel 10, a filter 12, a support 14, and an automated release mechanism 16. The brewing vessel 10 is shown as a bowl, but may be in the form of a cylindrically shaped vessel, cube shaped vessel, etc. The brewing vessel 10 has a bottom opening (not shown) and the automated release mechanism 16 may be positioned at least partially within the bottom opening, at least partially below the bottom opening and/or at least partially above the bottom opening. The filter 12 may be any type of paper filter, cloth filter, metal screen filter, etc., that allows water to flow from the brewing vessel 10 through the bottom opening of the brewing vessel 10, but prevents the flow or movement of most if not all flavored particles from the brewing vessel 10 through the bottom opening of the brewing vessel 10. In this manner, flavored particles are generally prevented from flowing through the automated release mechanism 16 and/or into a container 20 positioned below the support 14. The support 14 may be any type of support that allows the brewing vessel to be placed and supported onto the container 20 and may be part of the brewing vessel 10, automated release mechanism 16, etc., or in the alternative, may be a separate component from the brewing vessel 10, automated release mechanism 16, etc.

The automated release mechanism 16 has a hold position and a release position. In embodiments, the automated release mechanism 16 may be an automated drain valve 17 as depicted in FIGS. 2A-2B. FIG. 2A shows the automated release valve in a closed position and FIG. 2B shows the automated drain valve 17 in an open position. It should be understood that the automated drain valve 17 in the closed position is equivalent to the automated release mechanism 16 in the hold position and the automated drain valve 17 in the open position is equivalent to the automated release mechanism 16 in the release position. In the closed position (FIG. 2A), water contained in the brewing vessel 10 is prevented from flowing through an aperture 172 in a plate 170, while in the open position (FIG. 2B) water contained in the brewing vessel 10 is allowed to flow through the aperture 172 in the plate 170 and into the container 20. The automated drain valve 17 may include an electronic timer 18, a gate 174 and an actuator 178. An electronic control unit (ECU) 176 may optionally be included. A time set on the electronic timer 18 can be relatively short, e.g., during brewing of hot flavored beverage with a desired brewing time of 10 seconds, 15 seconds, 30 seconds, 60 seconds, 120 seconds, etc., or relatively long, e.g., during brewing of a cold flavored beverage with a desired brewing time of 5 minutes, 10 minutes, 30 minutes, 1 hour, 2 hours, 4 hours, 6 hours, 8 hours, 12 hours, etc.

In some embodiments, the electronic timer 18 is in communication with the actuator 178 such that a signal from the electronic timer 18, e.g., a signal that a time set on the electronic timer 18 has expired (“time expired signal”), is transmitted to the actuator 178 which in turn moves the gate 174 from the closed position (FIG. 2A) to the open position (FIG. 2B) upon receiving the time expired signal. In other embodiments, the electronic timer 18 transmits the time expired signal to the ECU 176, which in turn transmits an “open gate signal” to the actuator 178 and the actuator 178 moves the gate 174 from the closed position (FIG. 2A) to the open position (FIG. 2B) upon receiving the open gate signal. The actuator 178 may be any actuator that can move the gate 164 from the closed position to the open position, illustratively including but not limited to, a hydraulic actuator, a pneumatic actuator, an electrical actuator, a thermal actuator, a magnetic actuator, a mechanical actuator and the like. For example and without limitation, an actuator comprising a coil spring and an electromagnet can work in combination to hold the gate 174 in the closed position when the electromagnet is activated and move the gate from the closed position to the open position when the electromagnet is de-activated. In the alternative, an actuator comprising a coil spring and an electromagnet can work in combination to hold the gate 174 in the open position when the electromagnet is activated and move the gate from the open position to the closed position when the electromagnet is de-activated. It should be understood that the gate 174 can be moved back to the closed position automatically or manually after the flavored water flows from the brewing vessel 10 through the aperture 162 and into the container 20. It should also be understood that although FIGS. 2A-2B depict the automated drain valve 17 as a gate valve, other types of valves including but not limited to ball valves, butterfly valves, check valves, needle valves, and the like can be used to prevent, and then allow, flavored water from the brewing vessel 10 to flow through the aperture 172 and into the container 20 via the force of gravity.

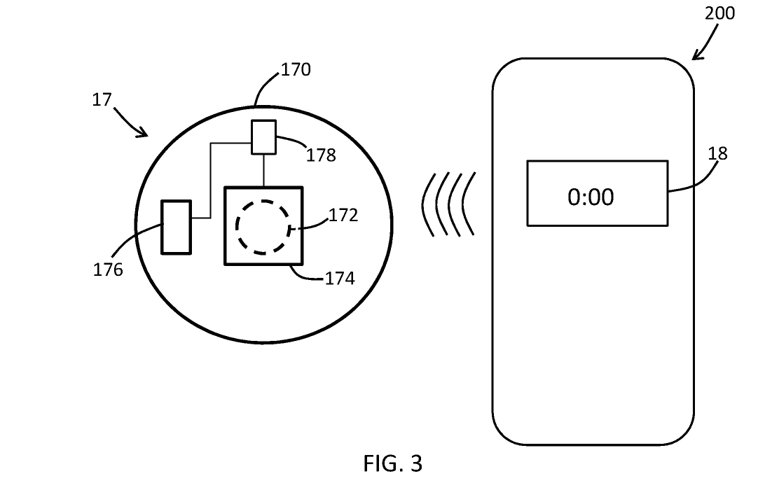

In some embodiments, the electronic timer 18 is in wired communication with the actuator 178 as depicted in FIGS. 2A-2B, while in other embodiments, the electronic timer 18 is in wireless communication with the actuator 178. For example, and as depicted in FIGS. 1-2B, the automated drain valve 17 and electronic timer 18 are part of a single unit. In other embodiments, the automated drain valve 17 and electronic timer 18 are part of two separate units as depicted in FIG. 3 in which the electronic timer 18 is part of a PED 200 that can transmit a wireless time expired signal to the ECU 76 and/or actuator 178. As used herein, a PED refers to any portable or personal electronic device, including without limitation a smart phone, a laptop computer, a tablet, a smart watch or the like. In this manner, a user can set a time for brewing on the electronic timer 18 that is part of the PED 200, and upon expiration of the time on the electronic timer 18, the PED 200 transmits a wireless time expired signal to the ECU 176 and/or actuator 178 such that brewing of the flavored beverage is terminated by the gate 174 moving from the closed position to the open position and the flavored water flowing from the brewing vessel through the aperture 172 into the container 20 via the force of gravity.

In operation, flavored particles C, T and water W are placed within the brewing vessel 10 and the flavored particles C, T are fulling immersed in the water W. The water and flavored particles are allowed to brew for a desired amount of time, e.g., a time period set on the electronic timer 18. When the time set on the electronic timer 18 has expired, a time expired signal is transmitted to the ECU 176 and/or actuator 178. In response to the time expired signal, the gate 164 moves from the closed position to the open position and flavored water in the brewing vessel 10 flows out of the brewing vessel 10 via gravity.

In some embodiments, flowing of the flavored water out of the brewing vessel 10 maybe assisted by another type of force, for example pressure. In one embodiment, the brewing vessel has a lid 19 cover the top opening (not labeled) depicted in FIG. 1. In the event that a hot flavored beverage is brewed, evaporation from hot water poured into the brewing vessel 10 creates steam which in turn may build up pressure within the brewing vessel. Accordingly, when the time expires on the electronic timer 18 and the automated drain valve 17 moves form the closed position to the open position, the pressure within the sealed brewing vessel assists (in addition to gravity) in the flow of the flavored water from the bottom opening of the brewing vessel 10 into the container 20.

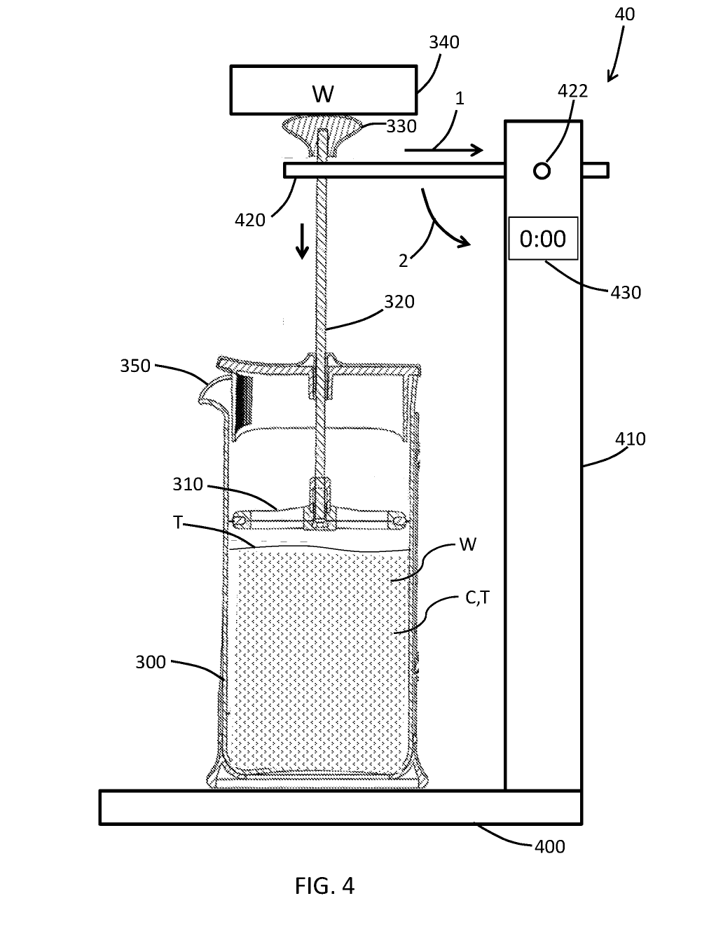

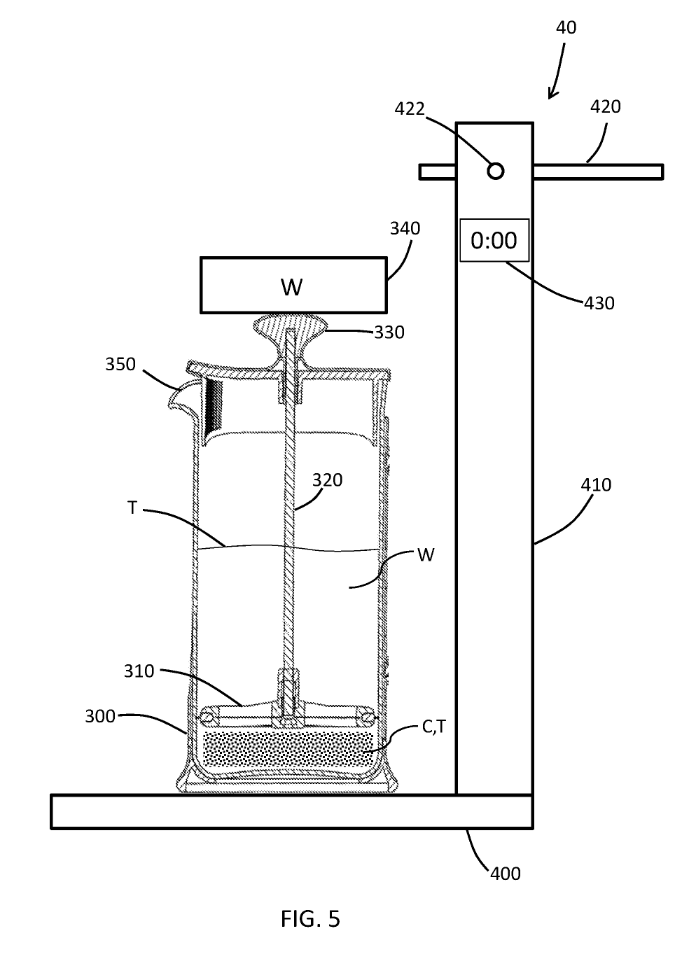

Referring now to FIGS. 4 and 5, a full immersion brewer in the form of a press brewer 30 and an automated release mechanism 40 are depicted. The press brewer 30 may include a press brewing vessel 300 (brewing vessel 300), a press filter 310, a press rod 320 and a handle 330. A weight 340 that exerts a force due to gravity on the press filter 310 (via press rod 320 and handle 330) may be included. The automated release mechanism 40 includes an automated release lever 420 and an electronic timer 430. The automated release mechanism 40 may be supported by a column 410 and the column may be supported by a base 400.

Flavored particles C, T and water W may be placed within the brewing vessel 300 with the flavored particles fully immersed in the water W. The water and flavored particles may be allowed to brew for a desired amount of time, after which the press filter 310 moves down through the water W to separate the flavored particles C, T from the water W. Particularly, the press filter 310 has screen or mesh openings that are smaller than most or all of the flavored particles C, T and thereby prevents most or all of the flavored particles C, T from passing through the press filter 310. Accordingly, the press filter 310 pushes the flavored particles C, T to a bottom portion of the brewing vessel 300 below the press filter 310 with the flavored water W remaining above the press filter 310 as depicted in FIG. 5. The flavored water is then poured out of the brewing vessel 300 via spout 350. It is understood that the water W is still in contact with the flavored particles C, T through the screen or mesh openings once the press filter 310 has separated the flavored particles C, T from the water as depicted in FIG. 5. However, it is also understood that the amount of brewing that occurs between the water and the flavored particles C, T is minimal and for the purposes of the instant disclosure the brewing is determined to have been terminated once the press filter 310 has reached the lower portion of the brewing vessel 300 as depicted in FIG. 5. This position of the press filter 310 may be determined or set as the position when the handle 330 abuts against a top cover (not labeled) of the brewing vessel 300 as depicted FIG. 5. In the alternative, or in addition to, this position of the press filter 310 may be determined or set as the position of the press filter 310 after it has stopped moving in a downward direction due to the equilibrium of the force from the weight 340 pushing down on the press filter 310 and the force of the flavored particles C, T pushing up on the press filter 310.

The automated release mechanism 40 provides an automated termination of brewing a flavored beverage in the press brewer 30 via the force of gravity. Particularly, the press filter 310 is held in the brewing position by the automated release lever 420 as depicted in FIG. 4. The automated release lever 420 may fit between the weight 340 and the press filter 310 and thereby prevent the weight 340 from applying a downward force on the press filter 310. In embodiments, the automated release lever may be positioned underneath the handle 330 to hold the handle 330 and weight 340 in a fixed position relative to a top surface T of the water W. Similar to the automated drain valve 17 in FIGS. 2A-2B, the electronic timer 430 is in communication with the automated release lever 420 via a wired communication or a wireless communication. Upon expiration of a time set on the electronic timer 430, a signal is transmitted to an actuator (not shown) which in turn moves the automated release lever 420 from a hold position as depicted in FIG. 4 to a release position as depicted in FIG. 5. Movement of the automated release lever 420 into the release position allows the weight 340 via the force of gravity to apply a downward force onto the press filter 310, e.g., through the handle and the press rod 320. The downward force is sufficient to move the press filter 310 through the water W within a given and desired amount of time and separates the flavored particles C, T from the water W. As noted above, separation of the flavored particle C, T from the water W terminates the brewing of the flavored beverage. As shown in FIG. 5, the press filter 310 pushes the flavored particles C, T to a bottom portion of the brewing vessel 300 with the water W being above the press filter 310.

Although FIGS. 4 and 5 depict the automated release lever 420 moving in a generally horizontal position (arrow 1) when the automated release lever 420 moves from the hold position (FIG. 4) to the release position (FIG. 5), it should be understood that other types of movement may be used to move the automated release lever 420 from the hold position to the release position. For example and without limitation, the automated release lever 420 may pivot about a pivot axis 422 and thereby pivot downwardly as indicted by arrow 2 in order to move the automated release lever 420 from the hold to the release position. Accordingly, any movement of the automated release lever 420 that allows the automated release lever 420 to move and allow the weight 340 to apply a force on the press filter 310 via gravity may be used. Also, the automated release mechanism may be in any form or component that prevents the weight 340 from exerting a force due to gravity on the press filter 310 including without limitation a clamp (e.g., a clamp on the press rod 320), a flange, etc., so long as the automated release mechanism has a hold position that prevents the weight 340 from applying a force due to gravity on the press filter 310 and a release position that allows the weight 340 to apply a force due to gravity on the press filter 310.

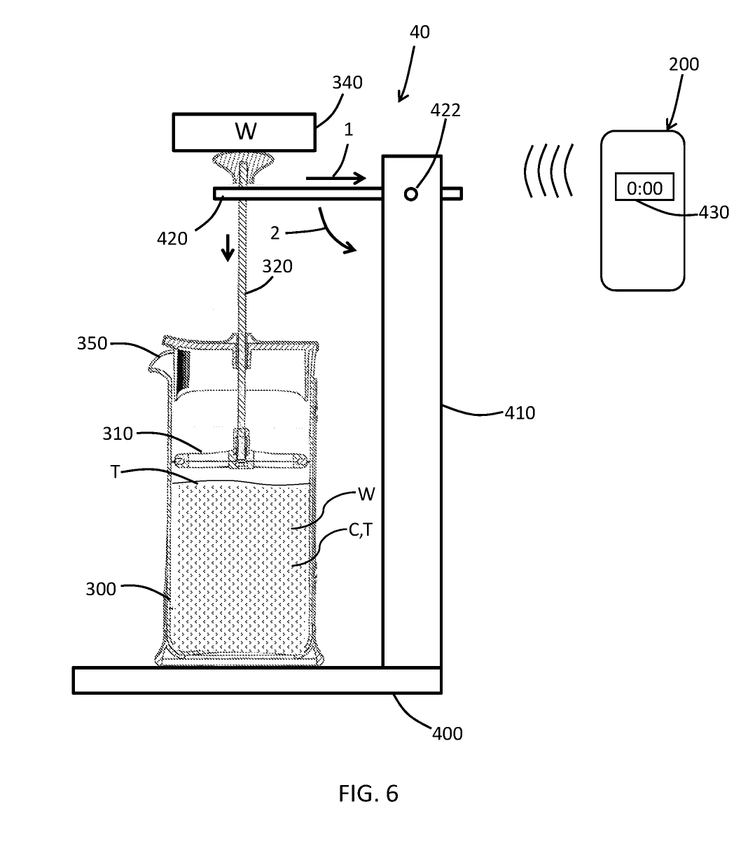

Similar to the embodiments described above in reference to FIGS. 1-3, the electronic timer 430 may be in wired communication and/or wireless communication with an actuator (not shown) and/or ECU (not shown). For example, in some embodiments the automated release lever 420 and electronic timer 430 are part of a single unit. In other embodiments, the automated release lever 420 and electronic timer 430 are part of two separate units as depicted in FIG. 6 in which the electronic timer 430 is part of the PED 200 that can transmit a wireless time expired signal to an ECU and/or actuator (not shown). In this manner, a user can set a time for brewing on the electronic timer 430 that is part of the PED 200, and upon expiration of the time on the electronic timer 430, the PED 200 transmits a wireless time expired signal to the ECU and/or actuator such that brewing of the flavored beverage is terminated by the automated release lever 420 moving from the hold position (FIG. 4) to the release position (FIG. 5) and the press filter 310 moving down through the brewing vessel 300 and separating the flavored particles C, T from the water W and thereby terminating the brewing of the flavored water W via the force of gravity.

Based on the foregoing, it should now be understood that the embodiments described herein relate to full immersion brewers for making coffee, tea, or the like. The full immersion brewers described herein may be constructed and used to prevent over-brewing of a flavorful drink. In some embodiments, the apparatuses and methods disclosed herein are used to provide for a single serving of a flavored beverage, e.g., a single serving brewing apparatus or a single serving brewing method used to manually make a single serving of flavored drink, i.e., without the use of motors, pumps, etc., for the flow of water within and/or out of the apparatuses. In other embodiments, the apparatuses and methods disclosed herein are used to provide for more than a single serving of a flavored beverage, e.g., a two serving brewing apparatus or a two serving brewing method used to manually make two servings of a flavored drink, i.e., without the use of motors, pumps, etc., for the flow of water within and/or out of the apparatuses.

It will be apparent to those skilled in the art that various modifications and variations can be made to the embodiments described herein without departing from the spirit and scope of the disclosed subject matter. Thus it is intended that the specification cover the modifications and variations of the various embodiments described herein provided such modification and variations come within the scope of the appended claims and their equivalents.

1. An apparatus for brewing a flavored beverage comprising:
a full immersion brewing vessel with an opening; and
an automated release mechanism with a hold position and a release position, wherein:
the automated release mechanism in the hold position is configured for flavored particles in the full immersion brewing vessel to be fully immersed in water such that brewing of the flavored beverage occurs;
the automated release mechanism in the release position is configured for brewing of the flavored beverage to be terminated via the force of gravity.

2. The apparatus of claim 1, wherein:
the automated release mechanism comprises an electronic timer and an automated drain valve;
the automated drain valve is positioned within a bottom opening of the full immersion brewing vessel and in communication with the electronic timer;
the automated drain valve is configured to automatically move from a closed position to an open positioned after a predetermined amount of time has elapsed on the electronic timer;
brewing of the flavored beverage is terminated via flavored water in the full immersion brewing vessel flowing out of the full immersion brewing vessel through the bottom opening via the force of gravity.

3. The apparatus of claim 2, wherein the electronic timer and the automated drain valve are located within a single unit positioned at a bottom portion of the full immersion brewing vessel and the electronic timer and the automated drain valve are in wired communication with each other.

4. The apparatus of claim 2, wherein the electronic timer and the automated drain valve are located in two separate units with the electronic timer and the automated drain valve in wireless communication with each other.

5. The apparatus of claim 2, further comprising a personal electronic device (PED), wherein the electronic timer is located within the PED and the PED is in wireless communication with the automated drain valve.

6. The apparatus of claim 1, wherein:
the full immersion brewing vessel is a press brewing vessel comprising a press filter and a weight configured to apply a downward force on the press filter via the force of gravity;
the automated release mechanism comprises an electronic timer and an automated release lever;
the automated release lever in the hold position is positioned between the weight and the press filter;
brewing of the flavored beverage is terminated via the press filter moving downward through the water and separating the water from the flavored particles when the automated release lever is in the release position and the weight applies the downward force on the press filter via the force of gravity.

7. The apparatus of claim 6, wherein the electronic timer and the automated release lever are located within a single unit and the electronic timer and the automated release lever are in wired communication with each other.

8. The apparatus of claim 6, wherein the electronic timer and the automated release lever are located in two separate units and the electronic timer and the automated release lever in wireless communication with each other.

9. The apparatus of claim 6, further comprising a personal electronic device (PED), wherein the electronic timer is located within the PED and the PED is in wireless communication with the automated release lever.

10. A process for making a flavored beverage with a full immersion brewer, the process comprising:
brewing the flavored beverage by fully immersing flavored particles in water within a full immersion brewing vessel comprising an automated release mechanism; and
automatically moving the automated release mechanism from a hold position to a release position after a predetermined amount of time has elapsed, wherein moving the automated release mechanism from the hold position to the release position terminates brewing of the flavored beverage via the force of gravity.

11. The process of claim 10, wherein:
the automated release mechanism comprises an electronic timer and an automated drain valve;
the automated drain valve is positioned within a bottom opening of the full immersion brewing vessel and in communication with the electronic timer;
the automated drain valve automatically moves from a closed position to an open position after the predetermined amount of time has elapsed on the electronic timer; and
brewing of the flavored beverage is terminated via the water in the full immersion brewing vessel flowing out of the full immersion brewing vessel through the bottom opening via the force of gravity.

12. The process of claim 11, wherein the electronic timer and the automated drain valve are located within a single unit positioned at a bottom portion of the full immersion brewing vessel and further comprising the electronic timer transmitting a time expired signal to the automated drain valve via a wired communication, and the automated drain valve moving from the closed position to the open position in response to the time expired signal transmitted from the electronic timer.

13. The process of claim 11, wherein the electronic timer and the automated drain valve are located in two separate units and further comprising the electronic timer transmitting a time expired signal to the automated drain valve via a wireless communication and the automated drain valve moving from the closed position to the open position in response to the time expired signal transmitted from the electronic timer.

14. The process of claim 13, wherein one of the two separate units is a personal electronic device (PED) comprising the electronic timer and further comprising the PED transmitting the time expired signal to the automated drain valve via the wireless communication and the automated drain valve moving from the closed position to the open position in response to the time expired signal transmitted from the PED.

15. The process of claim 10 wherein:
the full immersion brewer is a press brewer comprising a press filter and a weight configured to apply a downward force on the press filter via the force of gravity;
the automated release mechanism comprises an electronic timer and an automated release lever configured to move from the hold position to the release position after the predetermined amount of time has elapsed;
the automated release lever in the hold position is positioned between the weight and the press filter;
brewing of the flavored beverage is terminated via the press filter moving through the water and separating the water from the flavored particles when the automated release lever is in the release position and the weight applies the downward force on the press filter via the force of gravity.

16. The process of claim 15, wherein the electronic timer and the automated release lever are located within a single unit and further comprising the electronic timer transmitting a time expired signal to the automated release lever via a wired communication and the automated release lever moving from the hold position to the release position in response to the time expired signal transmitted from the electronic timer.

17. The apparatus of claim 15, wherein the electronic timer and the automated release lever are located in two separate units and further comprising the electronic timer transmitting a time expired signal to the automated release lever via a wireless communication and the automated release lever moving from the hold position to the release position in response to the time expired signal transmitted from the electronic timer.

18. The apparatus of claim 15, wherein one of the two separate units is a personal electronic device (PED) comprising the electronic timer and further comprising the PED transmitting a time expired signal to the automated release lever via a wireless communication and the automated release lever moving from the hold position to the release position in response to the time expired signal transmitted from the PED.
